(19) United States
(12) Patent Application Publication
(10) Pub. No.: US 2006/0021977 A1
(43) Pub. Date: Feb. 2, 2006

(54) Process and apparatus for scoring a brittle material incorporating moving optical assembly

(76) Inventor: Harry E. Menegus, Beaver Dams, NY (US)

Correspondence Address: CORNING INCORPORATED, SP-TI-3-1, CORNING, NY, 14831, US

(21) Appl. No.: 11/119,018

(22) Filed: Apr. 29, 2005

Related U.S. Application Data
(63) Continuation-in-part of application No. 10/903,701, filed on Jul. 30, 2004.

(51) Int. Cl. C03B 33/02; B23K 26/36; B23K 26/06

(52) U.S. Cl. 219/121.69; 219/121.78

(57) ABSTRACT

A method for scoring flat glass sheet includes moving an optical assembly, which is adapted to direct electromagnetic radiation from a radiation source. The method also includes impinging the electromagnetic radiation on a glass sheet, forming an elongated heating zone on the sheet, wherein a distance from the radiation source to the glass sheet is substantially constant during the moving. An apparatus is also described.

### CROSS-REFERENCE TO RELATED APPLICATIONS

The present application is a continuation-in-part and claims priority under 35 U.S.C. §120 U.S. patent application Ser. No. 10/903,701, commonly assigned, filed on Jul. 30, 2004, and entitled “PROCESS AND APPARATUS FOR SCORING A BRITTLE MATERIAL.” The entire contents of this application are specifically incorporated herein by reference.

### BACKGROUND OF THE INVENTION

1. Field of the Invention

The present invention relates to a method for breaking sheets and other brittle materials, more particularly a method for laser scoring of flat glass sheets.

2. Technical Background

Lasers have been used for separating sheets of brittle material, especially flat sheets of glass, by propagating a so-called blind crack across a glass sheet to break the sheet into two smaller glass sheets. This partial crack, which extends partway through the depth of the glass sheet, essentially operates as a score line. The sheet is then separated into two smaller sheets by mechanical breaking along the line of the score line.

Typically, a small nick or scribe is made on a surface at one side of the glass sheet. Next, a laser is directed to the location of the nick or scribe, which is then propagated in the form of a partial crack through the glass sheet using a laser. The laser is then contacted with the glass sheet in the area of the nick or scribe and the laser and glass sheet are moved relative to one another, so that the laser travels in the desired path of the score line. A stream of fluid coolant may be directed at a point on the heated surface of the glass just downstream from the laser, so that after the laser has heated a region of the glass sheet, the heated region is quickly cooled. In this way, the heating of the glass sheet by the laser and the cooling of the glass sheet by the fluid coolant creates stresses in the glass sheet which cause the crack to propagate in the direction that the laser and coolant have traveled.

The development of such laser scoring techniques has resulted in some good results in terms of quality break edges, making them potentially useful in the manufacture of liquid crystal and other flat panel display panel substrates, where the quality of edge breaks is desirably very high.

While advances in laser scoring have facilitated the processing of glass substrates for use in many applications, there are shortcomings of known processes and additional considerations of the process to be addressed. For example, many laser scoring apparati and methods include optical systems that are fixed in location, and the glass substrate is translated in two dimensions across the fixed laser beam. However, often the glass sheet from which the smaller glass substrates are formed can be rather large. In order to suitably translate the glass sheet for scoring, the facility dimension of the fabrication area can be unacceptably large.

Moreover, considerations of optimal distances from the laser to the glass are compromised as well. To this end, the shape and size of the laser spot required to effect the laser scoring of the material normally leaves little room for variance. One phenomenon of laser beams is angular divergence of the beam from the optic axis. As the distance is increased from the beam waist, the beam diverges and the spot size of the beam increases. As can be appreciated, if the beam spot size is optimally fixed for laser scoring, and due to motion of the optical system, the distance from the laser varies; the beam spot size also varies. This variation in the spot size can have a deleterious impact on the heating characteristics of the laser beam and thus of the scoring capability of the laser scoring apparatus.

### SUMMARY

In accordance with an example embodiment, a method for scoring flat glass sheet includes moving an optical assembly, which is adapted to direct electromagnetic radiation from a radiation source. The method also includes impinging the electromagnetic radiation on a glass sheet, forming an elongated heating zone on the sheet, wherein a distance from the radiation source to the glass sheet is substantially constant during the moving.

In accordance with another example embodiment, an apparatus for scoring a glass sheet includes a source of electromagnetic radiation. The apparatus also includes an optical assembly, which is adapted to the direct electromagnetic radiation to impinge on a glass sheet, forming an elongated heating zone on the sheet, wherein a beam length from the radiation source to the glass sheet is substantially constant during the scoring.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion.

FIG. 1a is a perspective view of a laser scoring apparatus in accordance with an example embodiment.

FIG. 1b is a perspective view of the glass sheet of FIG. 1a showing the relationship between the heating zone, the coolant spot and the crack resulting therefrom.

FIG. 2 is a graph of an intensity profile of a multimode laser beam in accordance with an example embodiment.

FIG. 3 is a graph of an intensity profile of a multimode laser beam in accordance with an example embodiment.

FIG. 4a is a perspective view of the output of a laser depicting certain useful distance measures and placement of a turning mirror in accordance with an example embodiment.

FIG. 4b is a top view of a laser scoring apparatus in accordance with an example embodiment.

FIG. 5 is a top view of a laser scoring apparatus in accordance with an example embodiment.

FIG. 6 is a top view of a laser scoring apparatus in accordance with an example embodiment.

### DETAILED DESCRIPTION

In the following detailed description, for purposes of explanation and not limitation, example embodiments disclosing specific details are set forth. However, it will be apparent to one having ordinary skill in the art having had the benefit of the present disclosure that other embodiments may be realized that depart from the specific details disclosed herein. Such embodiments are within scope of the appended claims. Moreover, descriptions of well-known apparati and methods may be omitted so as to not obscure the description of the example embodiments. Such methods and apparati are clearly within the contemplation of the inventors in carrying out the example embodiments.

Example embodiments relate to a system and method of breaking glass sheets along a desired line of separation using a laser scoring technique. A laser effectively heats a glass sheet in a localized heating zone along a desired line of separation. The temperature gradient thus produced induces tensile stresses in the surface layers of the material and as these stresses exceed the tensile strength of the material, the material develops a blind crack penetrating the material down to the regions which are under compression. Notably, a distance from the laser to the glass sheet (referred to herein as the beam length) upon which the laser beam is incident remains substantially constant during the scoring. As a result, the beam divergence or the effective impinging spot size of the beam remains substantially constant during the scoring.

In the described example embodiments that follow, the source of electromagnetic radiation used to effect the heating and subsequent scoring of the glass sheets is a radiation emission from a laser. Notably, this is merely an illustrative source of electromagnetic radiation. It is contemplated that other sources of radiation and other emission wavelengths may be used.

Specific details will now be set forth with respect to example embodiments depicted in the attached drawings. It is noted that like reference numerals refer to like elements.

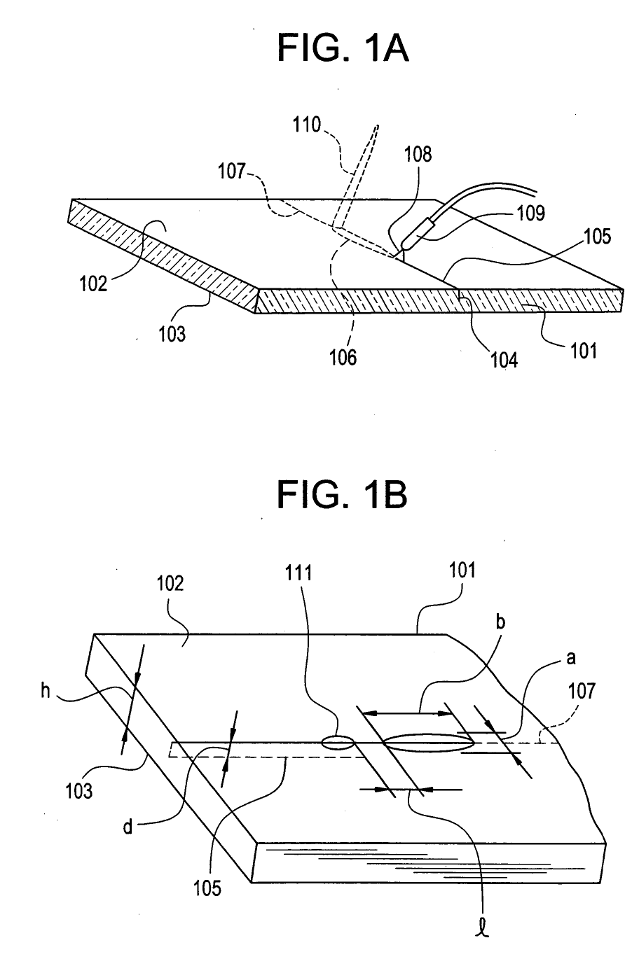

As illustrated in FIGS. 1a and 1b, in the glass breaking system of the present invention, glass sheet 101 has an upper major 102 and lower 103 major surface (not shown). Glass sheet 101 is first nicked or scored along one edge of the glass sheet to form crack initiation point 104 at one edge of glass sheet 101. Crack initiation point 104 is then used to form crack 105 by movement of heating zone 106 across glass sheet 101 along a pre-determined score path (the desired line of separation); such as that indicated by dashed line 107. Illustratively, coolant 108 is applied through nozzle 109 to enhance the stress distribution and thereby enhance crack propagation. Coolant 108 is illustratively a liquid, or an aerosol (or mist), but may be, for example, a gas. The coolant medium beneficially includes a material having a relatively high heat capacity. To this end, the higher the heat capacity, the faster the quenching of the heat and the faster the scoring speed. Illustratively, the coolant may be water. Alternatively, the coolant may be one of the so-called noble elements—helium, neon, argon, krypton, xenon and radon, or a combination thereof—which is applied to the glass sheet through nozzle 109.

In one embodiment, a tank (not shown) pressurized with air delivers coolant 108 through nozzle 109 onto upper glass surface 102 behind the traversing heating zone 106 created by a laser beam (generically indicated by reference numeral 110 in FIG. 1) impinging on surface 106 of the glass sheet. Illustratively nozzle 109 comprises a central passage through which a liquid coolant, e.g. water, is jetted. The central passage is surrounded by an annular passage through which pressurized air is flowed to collimate the liquid and break up the liquid flow to create an aerosol. An aerosol typically has a greater heat capacity than a gas and therefore provides enhanced cooling when compared to a gas. Illustratively the liquid is jetted through the central nozzle at a rate of at least about 3 ml/s, and forms a collimated spray of about 4 mm in diameter.

Alternatively, nozzle 109 is an ultrasonic nozzle supplied with a mixture of a suitable liquid coolant and air. If a liquid is applied to the surface of the glass, it is desirable to remove the excess liquid to prevent staining or other contamination of glass surface 102, for example by vacuuming the excess liquid. As heating zone 106 is moved across the glass, the crack follows the path traveled by the heating zone.

In still another alternative cooling method, nozzle 109 is a nozzle similar to those used for water jet cutting operations, wherein a concentrated jet of liquid is delivered to the glass surface. Such nozzles may have an outlet passage as small as 0.007 inches in diameter. Illustratively, nozzle 109 is within about 0.25 inches to 0.75 inches of upper glass surface 102 and delivers a spray pattern of between about 2 mm and 4 mm wide on the glass surface.

Because the temperature of the surface of glass sheet 101 at heating zone 106 is directly dependent on the time of exposure of the surface to the laser beam, employing a heating zone having an elongated (e.g. elliptical or rectangular) instead of a circular foot print extends the heating time for each point on surface 102 along predetermined score path 107 for the same rate of relative displacement of the heating zone. Hence, with a set power density for the laser beam, and with a constant distance l from the trailing edge of the heating zone to the front edge of coolant spot 111, which is essential for maintaining the desired heating depth of glass sheet 101, and the further heating zone 106 is extended in the displacement direction, the greater will be the allowable rate of the relative displacement of the heating zone across the glass surface.

As illustrated in FIG. 1b, in the present invention the heating zone has an extremely elongated shape, with major axis b greater than 30 mm. Beneficially, the major axis b is greater than approximately 50 mm; and even more beneficially greater than approximately 100 mm. Notably, the minor axis ‘a’ is less than approximately 7 mm. Elongated axis ‘b’ of the heating zone is aligned with the direction of travel of the predetermined scoring path across the glass sheet. For thin sheets of glass (e.g. less than about 1 mm), the optimum length of major axis b of the heating zone is related to the desired speed of travel in that major axis b should preferably be greater than 10 percent of the desired laser scoring speed per second. Thus, for a desired laser scoring speed of 500 mm/s on 0.7 mm thick glass, the major axis of the heating zone should preferably be at least 50 mm long.

Beneficially, crack 105 extends only substantially partially (distance d) into the depth of glass sheet 101 so that the crack acts as a score line. Final separation of the glass sheet into smaller sheets is then achieved by applying a bending moment under crack 105. Such a bending moment can be applied using conventional bending apparatus (not shown) and techniques such as are used to break glass sheets in processes employing more conventional mechanical surface scoring methods. Because crack 105 is formed using a laser scoring technique rather than mechanical scoring, the formation of glass chips during the mechanical breaking step is greatly minimized compared to past techniques.

The laser beam used for the glass breaking operation should be able to heat the surface of the glass to be cut. Consequently, the laser radiation preferably is at a wavelength which can be absorbed by the glass. For this to occur, the radiation should preferably be in the infra-red range, with a wavelength in excess of approximately 2.0 μm. To this end, in general glass becomes more transmissive with wavelengths below approximately 4.0 μm to approximately 5.0 μm and more opaque above this wavelength range. Thus, the glass becomes more opaque within the infra-red wavelength range, e.g. above 2.0 μm. So for glass scoring of the example embodiments, a 10.6 micron (10,600 nm) CO2 laser works well because it is heating the surface of the glass. This is in contrast to certain other lasers such as ND-YAG lasers that have an emission wavelength between 1.0 μm to approximately 1.1 μm and most often 1.06 μm. These wavelengths are in the transmissive range of glass. As can be appreciated from the present description, the transmission/absorption wavelengths of the material being scored dictates the useful laser. As such, lasers that emit wavelengths that are transmitted by glass, may be absorbed (that is the material is opaque) for brittle materials, such as ceramics, and thus be suitable for scoring these materials. As such, the laser is chosen to match the absorption characteristics of the material to be scored. In summary, the key point is brittle material dependant and to choose a laser wavelength, which is opaque to the material.

In an example embodiment, the laser is a CO₂ laser, with an emission wavelength of approximately 9.0 to approximately 11.0 μm. While the majority of current experiments have employed the use of CO₂ lasers having powers in the range of approximately 200 W to approximately 500 W, it is contemplated that even higher power lasers could be successfully used, for example, in excess of 600 W. It is emphasizes that the referenced laser output specifications are merely illustrative. In addition to the considerations of laser choice noted above, the laser is chosen so heating process provides a balance of beam length, traversal speed, spatial profile, which in combination can heat the spot area to as close as possible, but not exceeding the glass softening point (Tg). Additionally, given a small check in the glass exists—the coolant side requires a rapid most much localized quench to drive the partial crack.

Crack 105 is formed in the glass down to the interface of the heated and cooled zones, that is, in the area of the maximum thermal gradient. The depth, shape and direction of the crack are determined by the distribution of the thermoplastic stresses, which in turn are dependent primarily on the following several factors:

the power density of the laser beam,

the dimensions and shape of the heating zone produced by the laser beam;

the rate of relative displacement of the heating zone and the material;

the thermo physical properties, quality and conditions of supply of the coolant to the heated zone;

and the thermo physical and mechanical properties of the material to be cracked, its thickness, and the state of its surface.

Lasers operate by laser oscillation, which takes place in a resonant cavity defined by mirrors at each end. The concept of a stable resonator can best be visualized by following the path of a light ray through the cavity. The threshold of stability is reached if a light ray initially parallel to the axis of the laser cavity could be reflected forever back and forth between the two mirrors without escaping from between them.

Resonators which do not meet the stability criteria are called unstable resonators, because the light rays diverge away from the axis. There are many variations on the unstable resonator. One simple example is a convex spherical mirror opposite a flat mirror. Others include concave mirrors of different diameters (so that the light reflected from the larger mirror escapes around the edges of the smaller one), and pairs of convex mirrors.

The two types of resonators have different advantages and different mode patterns. The stable resonator concentrates light along the laser axis, extracting energy efficiently from that region, but not from the outer regions far from the axis. The beam it produces has an intensity peak in the center, and a Gaussian drop in intensity with increasing distance from the axis. Low-gain and continuous-wave lasers are primarily of this type.

The unstable resonator tends to spread the light inside the laser cavity over a larger volume. For example, the output beam may have an annular profile, with peak intensity in a ring around the axis.

Laser resonators have two distinct types of modes: transverse and longitudinal. Transverse modes manifest themselves in the cross-sectional profile of the beam, that is, in its intensity pattern. Longitudinal modes correspond to different resonances along the length of the laser cavity which occur at different frequencies or wavelengths within the gain bandwidth of the laser. A single transverse mode laser that oscillates in a single longitudinal mode is oscillating at only a single frequency; one oscillating in two longitudinal modes is simultaneously oscillating at two separate (but usually closely spaced) wavelengths.

The “shape” of the electromagnetic field within the laser resonator is dependent upon the mirror curvature, spacing, bore diameter of the discharge tube, and the wavelength. Small changes in mirror alignment distance from the laser to the surface 102, or wavelength can cause dramatic changes in the “shape” of the laser beam (which is an electromagnetic field). A special terminology has evolved for describing the “shape”, or energy distribution in space, of the beam, in which transverse modes are classified according to the number of nulls that appear across the beam cross section in two directions. The lowest-order, or fundamental mode, where intensity peaks at the center, is known as the TEM₀₀ mode. Such lasers are commonly preferred for many industrial applications. A transverse mode with a single null along one axis and no null in the perpendicular direction is TEM₀₁ or TEM₁₀, depending on orientation. TEM₀₁ and TEM₁₀ mode beams have been used in the prior art to deliver laser energy uniformly to the glass surface.

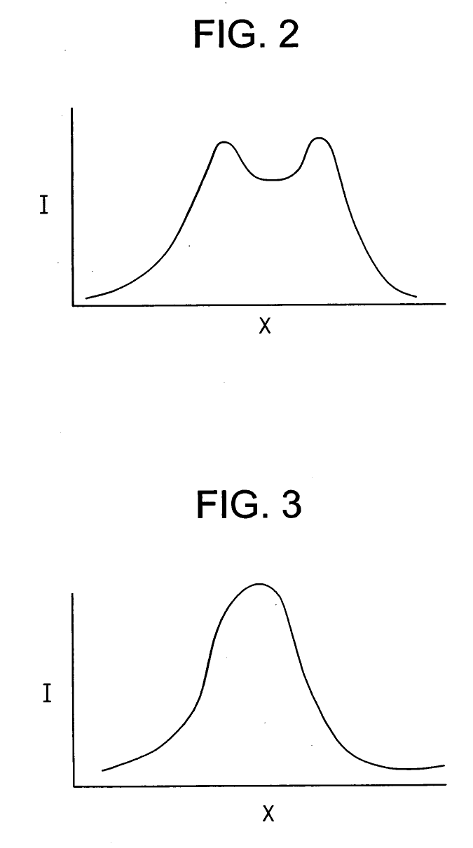

The laser beam illustrated in FIG. 2 (beam intensity I vs. distance x across the beam), consists essentially of an annular ring. The center of the laser beam thus has lower power intensity than at least some of the outer regions of the laser beam, and may go completely to a zero power level, in which case the laser beam would be a 100 percent TEM₀₁* power distribution. Such a laser beam is bimodal. That is, it incorporates levels of more than one mode, such as a combination of TEM₀₁* and TEM₀₀ modes, wherein the power distribution of the center region merely dips below that of the outer region. In cases in which the beam is bimodal, the beam may incorporate greater than 50 percent TEM₀₁*, the remainder being the TEM₀₀ mode. However, as described above, multimoded laser devices needed to produce such optical power profiles may suffer from poor stability and may also be difficult to align and maintain.

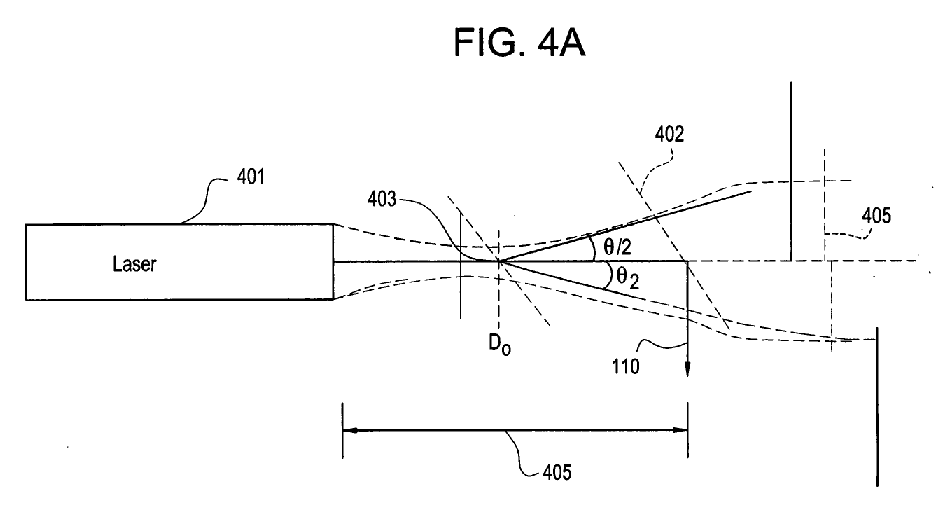

It has been thought that non-Gaussian laser beams were preferred for laser scoring operations as they provided improved uniformity of energy distribution across the beam when compared to Gaussian laser beams. However, a beam having a Gaussian power distribution, when suitably manipulated, is capable of performing the requisite scoring function while taking advantage of the economics, stability and low maintenance associated with single-moded, Gaussian lasers. Notably, particularly low maintenance laser are associated with sealed tube lasers. These lasers typically only emit the TEM₀₀ mode. In accordance with example embodiments, a single-mode laser having a continuously emitting beam with a generally Gaussian power profile may be used. A representative mode power distribution of such a laser is illustrated in FIG.3. Illustratively, the beam is comprised essentially of the TEM₀₀ mode.

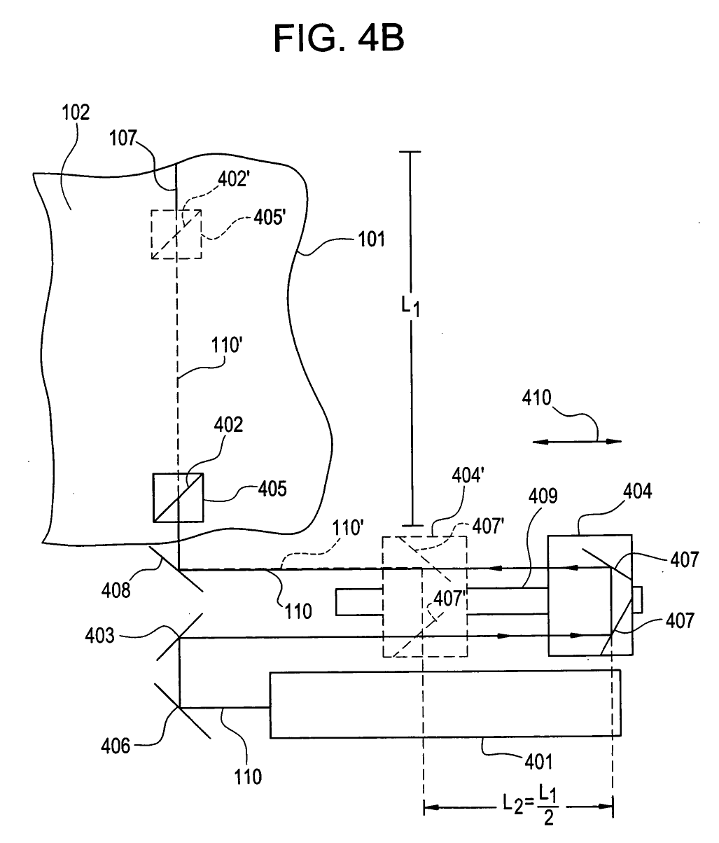

In accordance with example embodiments described herein, the distance from the laser to surface 102 of glass sheet 101 remains substantially fixed during the scoring process. The basis for maintaining this substantially fixed distance may be understood from a review of FIG. 4a. FIG. 4a shows laser 401 projecting light directly. The beam 110 may be turned by mirror 402 as shown. Beam 110 from the laser includes a beam waist at a location Dₒ from the endface of the laser. The beam waist is the narrowest or smallest cross-section of the beam, and therefore, provides the greatest intensity (power/unit area) of the beam. Beginning at beam waist 403, the beam begins a divergence at an angle θ/2. Thus, with the beam divergence, the spot size increases and the intensity decreases. As referenced previously, the determination and substantially fixing of the spot size of a particular laser for a particular scoring application is fundamental to the success of the scoring. At Rayliegh length 404, (2)^{1/2} Dₒ, the spot size is too large to effectively score glass sheet 101.

In accordance with an example embodiment, a distance from laser 401 at which turning mirror 402 directs beam 110 to surface 102 of glass sheet 101 is substantially fixed along the length of heating path 105. Notably, this distance plus a substantially fixed distance from mirror 402 to surface 102 of substrate 101 provides the optimal spot size of beam 110 to effect the laser scoring for the material characteristics of the representative glass sheet 101. Beneficially, because the beam length remains substantially fixed at a chosen optimal value, the beam shape remains substantially fixed at an optimal spot size at surface 102 of the glass sheet, thereby fostering the heating and scoring of the glass. Contrastingly, in many applications where the laser moves to effect scoring, the beam length increases or decreases during the scoring process. This can alter the divergence of the laser beam and therefore modify heating zone 106 by modifying the size of the radiation spot (spot size) from beam 110 impinging on the glass. That is, as the beam length increases (decreases) and laser beam 110 diverges as a result, the spot size increases (decreases). The increased (decreased) spot size may in turn undesirably reduce (increase) the heating effectiveness of the heating zone, such as by increasing (decreasing) the size of heating zone 106 to other than its optimal size.

It is noted that as described in the above-captioned parent application, one or more lens elements may be disposed between turning mirror 402 and surface 102 to provide the beneficial elliptical or elongated cross-section of beam 110. For example, two cylindrical lenses (not shown) may be used to form the shape of the spot, as shown in connection with FIG. 1b.

While various descriptions of the present invention are described above, it is understood that the various features described in connection with the embodiments of the present invention can be used singly or in combination thereof. Therefore, this invention is not to be limited to the specifically preferred embodiments depicted therein.

FIG. 4b is a top view of a scoring apparatus in accordance with an example embodiment. The scoring apparatus includes laser 401, which emits beam 110. Beam 110 is incident on reflective surface (mirror) 402 and another reflective surface (mirror) 403. Mirror 403 turns beam 110, which is in turn incident on first optical head 404. First optical head 404 includes mirrors 407 as shown, which direct beam 110 to another reflective surface (mirror) 408, which directs beam 110 to second optical head 405. Second optical head 405 includes turning mirror 402, which directs beam 110 to surface 102 of glass sheet 101.

First optical head 404 is disposed over linear slide (or rail) 409, which guides the optical head in directions 410 during the scoring operation. In the present example embodiment, first optical head 404 and slide 409 comprise a slack loop. Linear slide 409 may include, but certainly is not limited to, known rails and a servo-controlled motor or precision ball screw mechanism. Alternatively, the linear slide may include a linear servo motor and a linear rail system. Beneficially, these known elements will provide linear motion of the optical head in a controlled manner with insignificant motion in the two directions perpendicular to direction 410. As will become clearer as the present description continues, the relatively smooth linear traversal of first optical head 404 along linear slide 409 fosters precise linear movement of beam 110 along scoring path 107.

In operation, first optical head 404 translates along slide 409 and second optical head 405 translates over glass sheet 101. Second optical head 405 translates via a carriage head or similar device (not shown), which are known to one having ordinary skill in the art. The linear speed of first optical head 404 is at substantially the same as the linear speed of second optical head 405. Ultimately, the first optical head moves to the far end of slide 409 as shown in dotted line at 404′; and by virtue of the commensurate motion of second optical head 405, the second optical head reaches the endpoint (as shown in dotted line 405′) of its scoring length at the same time.

Moreover, as shown in FIG. 4b, second optical head 404 traverses a distance L₁ above surface 102 of glass sheet 101. During the motion of second optical head 404, the first optical head traverses a length L₁/2, which is referred to as the slack length. To this end, the motion of second optical head 405 is over a length L₁. Therefore, the beam path added or subtracted to keep the first and second optical heads synchronous is equal to the length L₁, which in a single loop arrangement such as the example embodiment of FIG. 4b, requires first optical head 404 to move a distance L₁/2. As described more clearly in conjunction with the example embodiments, the slack length may be reduced by providing additional optical heads and ‘loops’ in the slack loop.

As can be appreciated, because the relative linear speed of the first optical head and the second optical head as substantially the same, the distance between the two optical heads remains the same. This substantially null relative speed between the first and second optical heads translates into a substantially constant distance traveled by beam 110 from the endface of laser 401 to turning mirror 402, regardless of the position of second optical head 405 along scoring path 107. Stated a bit differently, beam distance 110 from laser 401 to turning mirror 402 is substantially identical regardless of the position of second optical head 405 along score path 107. This can be readily determined from a review of FIG. 4b. To this end, the beam length of beam 110 from laser 401 to second optical head 405 is the same as the beam length of beam 110′ (dotted line) to second optical head 405′, which has traversed the length of scoring path 107.

In the example embodiment shown in FIG. 4b, the distance from laser 401 to second optical head 405 is substantially constant as first optical head 404 traverses the slack length and the second optical head traverses the distance L₁; and the distance from second optical head 405 to surface 102 of the glass sheet is substantially constant as the second optical head translates over score path 107. Therefore, the beam length from laser 401 to surface 102 is substantially constant; and having been calculated for an optimal beam shape for heating region 106, the chosen beam length ensures substantially constant beam shape and heating region along the scoring path.

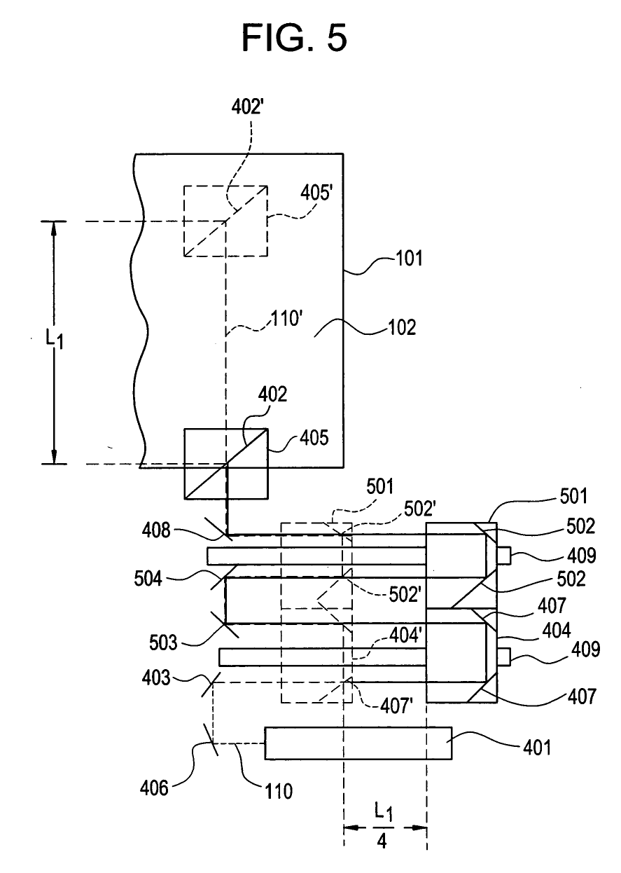

In order to reduce the slack length and thus the distance over which the components of the slack loop must travel, additional loops may be added. An example embodiment which reduces the slack length to L₁/4 is shown in and described in connection with FIG. 5. It is noted that many of the features of the example embodiment of FIG. 5 are common to those described in connection with FIGS. 4a and 4b. Many of these common features are not described in detail to avoid obscuring the description of the present example embodiment.

In operation, beam 110 is emitted from laser 401 and is incident on mirror 406, and then upon mirrors 407 of first optical head 404. Next, beam 110 is incident on the reflective surface (mirror) 503, and then onto third optical head 501, which comprises reflective surfaces (mirrors) 502 as shown. Beam 110 is reflected by mirrors 502 to mirror 408 and then to second optical head 404.

Like the example embodiment described in connection with FIG. 4b, the present example embodiment provides the movement of second optical head 404 over glass sheet 101. However, in the present example embodiment, a slack loop is comprised of first and third optical heads, 404 and 503, respectively, which move simultaneously in the same direction along slides 409. The motion of the slack loop components is also in concert with the motion of second optical head 404. To this end, as first and third optical heads 404 and 501, respectively, move from their initial position (solid line) to their final positions where they are shown as 404′ and 501′, respectively, second optical head 404 moves from its initial position to its final position, where it is shown as 404′. As described previously, beam 110 travels the same distance as beam 110′, and thereby preserves the beam length and beam shape.

However, unlike the example embodiment of FIG. 4b, the example embodiment of FIG. 5 has a slack length that is equal to (L₁/4). To wit, by virtue of the additional loop provided by third optical head 501, the slack length is reduced. Beneficially, this allows the scoring path of length L₁ to be traversed by the third optical head with a slack loop that requires less area and slack length.

Notably, the scoring process and the relative motion of the second optical head 405 is substantially the same as described in connection with the example embodiment of FIG. 4b. Most notably, like the example embodiment of FIG. 4b, the beam length of beam 110 (110′) at any point along scoring path 107 is substantially the same. As described previously, this fosters an optimal scoring procedure with a chosen optimal beam length that provides an optimal heating region 106. Finally, the use of a second loop is merely illustrative. Clearly additional loops may be added using additional optical heads and rails. Each such loop will further reduce the slack length by one-half of the slack loop with one fewer loops.

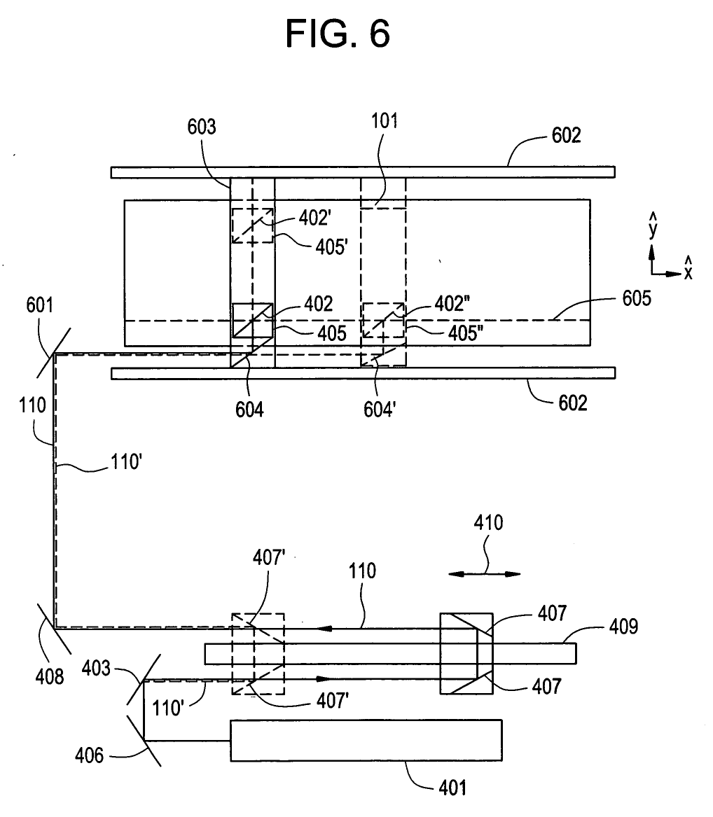

FIG. 6 is a top-view of a laser scoring apparatus adapted to score along two axes, the y-axis as described in conjunction with the example embodiments previously, and the x-axis. It is noted that many of the features of the example embodiment of FIG. 6 are common to those described in connection with FIGS. 4a-5. Many of these common features are not described in detail to avoid obscuring the description of the present example embodiment.

Light incident on mirror 601 is reflected to another mirror 604, which is disposed on part of carriage 603 and tracks linearly in the x-direction along guide rail 602. The scoring in the y-direction proceeds as described previously. Either before or after the scoring in the y-direction is completed, scoring in the x-direction is carried out.

Scoring in the x-direction is effected by the locating of a position to provide scored line 605 along the surface of substrate 101. As with y-direction scoring, the scoring in the x-direction is carried out by moving carriage 603 in the x-direction, with second optical head 405″ (and mirror 402″) remaining in a substantially fixed y-position on the carriage. Notably, in keeping with the example embodiments described previously, the length of the scoring along scored line 605 is equal to approximately twice the distance traversed by first optical head 404 along linear slide 409. Moreover, as described in connection with the example embodiment of FIG. 5, the length of scored line 605 may be approximately four times the distance traveled by the first optical head along slide 409.

Notably, the y-position of scored line 605 may be adjusted by moving second optical head 405″ to another y-position and fixing the position of the second optical head. Movement of first optical head 404 and second optical head 405″ provides the scored line, with a length determined as above.

The following example, which is intended to be illustrative rather than limiting, demonstrate methods in accordance with the example embodiments.

### EXAMPLE

A single-mode CO₂ laser having a power of between about 250 and 500 watts is passed through a collimator, wherein a substantially collimated beam exits the collimator. The collimated beam is thereafter passed through an integrator lens which redistributes the single beam into a plurality of discrete beams. The discrete beams are impinged upon the surface of a glass sheet in an elongated pattern, thereby forming an elongated heating zone wherein the optical power impinging on an outer region of the heating zone is greater than the optical power impinging upon a central portion of the elongated heating zone. Relative motion is developed between the heating zone and the glass sheet wherein the heating zone traverses the glass sheet at a rate of at least about 300 mm/s. A coolant is jetted against the glass sheet behind the traversing heating zone. The heating zone is at least about 30 mm in length along a direction parallel with the direction of relative motion.

It will be apparent to those skilled in the art that various other modifications and variations can be made to the present invention without departing from the spirit and scope of the invention. For example, although the general scoring methods disclosed herein are described with respect to sheets of glass, they may be further applied to other brittle materials, such as glass-ceramics. Thus it is intended that the present invention cover the modifications and variations of this invention provided they come within the scope of the appended claims and their equivalents

What is claimed is:

1. A method for scoring flat glass sheets, the method comprising:
moving an optical assembly, which is adapted to direct electromagnetic radiation from a radiation source;
impinging the electromagnetic radiation on a glass sheet, forming an elongated heating zone on the sheet, wherein a distance from the radiation source to the glass sheet is substantially constant during the moving.

2. The method of claim 1, wherein the impinging further comprises reflecting the electromagnetic radiation from the radiation source and focusing the electromagnetic radiation on the sheet.

3. The method of claim 2, wherein the radiation source is a laser and the electromagnetic radiation is light.

4. The method of claim 1, wherein the radiation source is substantially stationary.

5. The method of claim 1, wherein the glass sheet is substantially stationary.

6. The method of claim 1, wherein the electromagnetic radiation impinging on the glass sheet translates along a length of the glass sheet during the moving.

7. The method of claim 6, wherein the electromagnetic radiation translates at a rate of at least approximately 300 mm/s, thereby forming a heated scoring path.

8. The method of claim 7, further comprising contacting the heated scoring path with a cooling material.

9. The method of claim 1, wherein the optical subassembly moves along a linear slide device.

10. The method of claim 3, further comprising collimating the light from the laser and directing the light onto the optical assembly.

11. The method of claim 1, wherein the light includes multiple eigenmodes.

12. The method of claim 1, wherein providing variable slack in a length of motion of the optical assembly maintains the distance substantially constant.

13. The method of claim 1, wherein the elongated heating zone has a temperature minimum within a central portion of the heating zone.

14. The method as recited in claim 1, wherein the method further provides scoring in a first direction and in a second direction, wherein the first direction is substantially orthogonal to the first direction.

15. An apparatus for scoring a glass sheet comprising:
a source of electromagnetic radiation;
an optical assembly, which is adapted to the direct electromagnetic radiation to impinge on a glass sheet, forming an elongated heating zone on the sheet, wherein a beam length from the radiation source to the glass sheet is substantially constant during the scoring.

16. An apparatus as recited in claim 15, wherein the optical assembly further comprises:
a slack loop, which comprises a first optical head and a rail, which guides the first optical head during a translation; and
a second optical head, which directs the electromagnetic radiation to the glass sheet.

17. An apparatus as recited in claim 16, wherein the slack loop further comprises a third optical head and another rail, which guides the third optical head during a translation.

18. An apparatus as recited in claim 16, wherein the second optical head traverses a distance L₁ and the first optical head traverses a length 0.5 L₁ across the rail.

19. An apparatus as recited in claim 17, wherein the second optical head traverses a distance L₁ and the first optical head and the third optical head each traverse a length 0.25 L₁ across the rail.

20. An apparatus as recited in claim 16, wherein the second optical head is adapted to move in a first direction and in a second direction, which is substantially orthogonal to the first direction.
